(19) United States
(12) Patent Application Publication
(10) Pub. No.: US 2011/0295415 A1
(43) Pub. Date: Dec. 1, 2011

(54) REMOTE TRANSACTION SYSTEM UTILIZING COMPACT ANTENNA ASSEMBLY

(76) Inventors: Jack Francis Bartlett, Summerfield, NC (US); Wayne McNinch, Greensboro, NC (US); Howard Myers, Greensboro, NC (US); Roger William Stout, Greensboro, NC (US); Lester Grant Ward, Greensboro, NC (US)

(21) Appl. No.: 12/791,339

(22) Filed: Jun. 1, 2010

(51) Int. Cl. G06F 17/00; H01Q 1/24; G06Q 20/00

(52) U.S. Cl. 700/232; 705/17; 343/702

(57) ABSTRACT

A remote transaction system for contactless payment and user identification at dispensers, payment terminals, kiosks, or points-of-sale is provided. The remote transaction system comprises a compact assembly, a control system, and communications electronics. The compact assembly is adapted to be attached to a surface, such as a bezel, and comprises at least one antenna. Also, the compact assembly may comprise antennas operating at different frequencies and at least one audio or visual element. Further, antenna arrays may be formed comprising a second antenna arrangement separate from the compact assembly and coupled to the surface. The compact assembly and/or a second antenna arrangement may comprise a tuning element, such as a tuning ring. The communications electronics are adapted to wirelessly communicate with at least one remote communications device and provide wireless communications to the control system for processing. A method for attaching the compact assembly to a surface is also provided.

### FIELD OF THE INVENTION

The present invention relates generally to fuel dispensers and outdoor payment terminals or kiosks utilizing a radio frequency identification (RFID) system for contactless card payment and customer or operator identification. More specifically, the invention provides a compact antenna assembly for use in such a dispenser, payment terminal, or kiosk.

### BACKGROUND OF THE INVENTION

Radio-frequency identification (RFID) technology is known for communications, retail, manufacturing, identification, and control applications. RFID systems typically comprise a tag, a transceiver, and a processor that may be connected to a host computer or point-of-sale (POS) device. The transceiver, or interrogator, has at least one antenna, a microprocessor, and other electronic circuitry. The tag, or transponder, often has transponder electronic circuitry and an antenna. The electronic circuitry of the tag may include a capacitor, nonvolatile memory, and/or control logic. Passive transponders use a signal from the interrogator to provide energy which activates the transponder's circuitry, while active transponders contain an independent energy source such as a battery. In one familiar mode of operation, the interrogator sends an interrogation signal to the transponder at a first frequency, the transponder responds by transmitting a coded signal on a second frequency, and the interrogator receives and processes the coded signal. The interrogator sends the information contained in the coded signal to the dispenser controller, which may pass it on for further processing to a host computer associated with a remote network.

In recent years, traditional gasoline dispensers have evolved into elaborate POS devices having sophisticated control electronics and user interfaces with large displays. The dispensers include various types of payment means, such as card readers and/or cash acceptors, to expedite and further enhance fueling transactions. Some recent dispensers allow the customer to purchase services, such as car washes, and goods, such as fast food or other convenience store products, at the dispenser. Once purchased, the customer need only pick up the goods and services at the station store or the outlet of a vending machine.

Advances to modern dispensers also include remote transaction systems employing RFID technology. In this regard, a customer or a vehicle carries a transponder to provide automatically various types of identification and information to the fuel dispenser. The dispensers themselves include antennas arranged to communicate remotely with the transponder when in range.

For example, this technology allows a customer to provide loyalty program or account information by waving the transponder in front of an area of the dispenser behind which a radio-frequency (RF) antenna is mounted. Either the transponder actively emits an RF signal containing the information or the antenna emits a radiation pattern that energizes the transponder, allowing it to emit a responsive signal when placed within the pattern. The antenna receives the transponder signal and transmits the information to a controller processor in the fuel dispenser and/or to a POS device in the central building of the service station. The information may then be communicated to a credit-processing host. Further information on RFID payments and interaction with a fuel dispenser is provided in commonly-owned U.S. Pat. No. 6,073,840, entitled “Fuel Dispensing and Retail System Providing for Transponder Prepayment,” issued Jun. 13, 2000, which is incorporated herein by reference in its entirety for all purposes.

The effectiveness of transceiver antennas in these systems is dependent upon their ability to send and receive RF signals. As noted above, RFID antennas are typically mounted within the interior of the gasoline dispenser, behind a “window.” The enclosure's thickness plus any mounting features, however, can be a substantial portion of the total available read range. Also, the enclosure's material, which may be metal, can affect the impedance and/or other characteristics of the antenna, thereby reducing the antenna's ability to send and receive RF signals. Further, mounting the antenna within an enclosure makes the provision of backlighted graphics or other aesthetic features associated with the antenna space difficult.

Previous solutions include increasing the signal strength to improve read range. However, this solution may be limited by government regulation. Another solution includes increasing the RF antenna's size, but often the enclosure in which the RF antenna is mounted contains many other electronic components. Thus, there are a limited number of acceptable interior mounting locations for such components. A further solution involves retrofitting fuel dispensers with a loop antenna mounted to the top of the dispenser. However, these arrangements may be unsightly and conflict with signage and decoration panels mounted at the top of many existing dispensers. Further room for improvement thus exists in the art.

### SUMMARY OF THE INVENTION

According to one aspect, the present invention provides a remote transaction system comprising a compact assembly adapted to be attached to a surface, wherein the compact assembly comprises at least one antenna. Further, the compact assembly comprises communications electronics adapted to receive a remote communications signal from at least one remote communications device using the at least one antenna. Also, the communications electronics are adapted to extract identification information from the remote communications signal and provide the identification information to a control system.

According to a further aspect, the present invention provides an antenna array comprising a first antenna arrangement comprising at least one antenna located in a compact assembly. The compact assembly is adapted to be attached to a surface. The antenna array further comprises communications electronics adapted to wirelessly communicate with at least one remote communications device using the first antenna arrangement. Finally, the antenna array comprises a control system in electronic communication with the communications electronics adapted to process wireless communications received by the communications electronics.

Yet another aspect of the present invention provides a fuel dispenser comprising a fuel dispenser housing and a control system. The fuel dispenser also comprises a compact assembly mounted to an exterior surface of the fuel dispenser housing, wherein the compact assembly comprises at least one antenna. In addition, the fuel dispenser comprises communications electronics in electronic communication with the control system and adapted to receive signals including identification indicia from at least one remote communications unit using the at least one antenna.

A still further aspect of the present invention provides a method for attaching a compact assembly to a fuel dispenser. The method comprises providing a compact assembly having circuitry and a connector, wherein the compact assembly comprises at least one antenna; affixing the compact assembly to an exterior surface of the fuel dispenser; and connecting the circuitry of the compact assembly to circuitry in the fuel dispenser via the connector.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1A is a diagrammatic representation of a transponder constructed in accordance with an embodiment of the present invention.

FIG. 1B is a diagrammatic representation of a transponder having integrated electronics constructed in accordance with an embodiment of the present invention.

FIG. 2 is a schematic of a fueling environment constructed and implemented in accordance with an embodiment of the present invention including various possible transponders interacting with fuel dispensers and a host network through a central control system.

FIG. 3 is a front elevational view of an exemplary fuel dispenser that operates with a POS device and/or a site controller within a retail fueling environment in accordance with an embodiment of the present invention.

FIG. 4 is a diagrammatic representation of fuel dispenser electronics constructed in accordance with an embodiment of the present invention.

FIG. 5A shows a detailed view of a front panel of a fuel dispenser housing containing a prior art remote transaction system.

FIG. 5B is a detailed perspective view of the construction of the prior art remote transaction system of FIG. 5A when viewed from the interior of the fuel dispenser.

FIG. 6 is a perspective view of a compact antenna assembly in the form of a module in accordance with an embodiment of the present invention.

FIG. 7 is a back perspective view of the compact antenna module of FIG. 6.

FIG. 8 is a perspective view of a substrate that includes an antenna loop and several light-emitting diodes (LEDs) constructed in accordance with an embodiment of the present invention.

FIG. 9 is a perspective view of an adhesive layer designed to be received around an electronics module on the back of the substrate of FIG. 8.

FIG. 10 is an exploded view of the compact antenna module of FIG. 6.

FIG. 11 is a diagrammatic representation of the interrogator electronics associated with the compact antenna module of FIG. 6 constructed in accordance with an embodiment of the present invention.

FIG. 12A is a front perspective view of the compact antenna module of FIG. 6 mounted in a bezel section in accordance with an embodiment of the present invention.

FIG. 12B is a rear perspective view of the bezel section of FIG. 14A with the compact antenna module of FIG. 6 received therein.

FIG. 13 is an antenna array comprising a compact antenna module attached to a surface of an enclosure which has two antennas mounted in its interior according to one embodiment of the present invention.

FIG. 14A is a plan view of a tuning element having a narrow slot according to an embodiment of the present invention.

FIG. 14B is a plan view of a slotless tuning element without a narrow slot according to an embodiment of the present invention.

FIG. 15 is a diagrammatic side view of a compact antenna module affixed to a surface of an enclosure according to an embodiment of the present invention.

FIG. 16 is a diagrammatic side view of a compact antenna module comprising a multi-layer antenna array according to an embodiment of the present invention.

FIG. 17 is an exploded perspective view of the multi-layer compact antenna array of FIG. 16 in accordance with an embodiment of the present invention.

FIG. 18 is a top view of the multi-layer compact array of FIGS. 16 and 17 according to an embodiment of the present invention.

FIG. 19 is a diagrammatic side view of a compact antenna module comprising a multi-layer antenna array according to an embodiment of the present invention wherein the multi-layer antenna array also includes a tuning element.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention provides a remote transaction system comprising remote communication units and communications electronics. The remote transaction system includes a compact assembly employing one or more antennas and/or tuning elements that is adapted to be attached to a surface, such as, but not limited to, the surface of an enclosure, a bezel, a counter, or a POS device. The term “transaction” as used herein broadly includes any exchange of data or information, such as account or financial information, customer or vehicle identification, customer requirements, authorization, diagnostics, advertising, and various other types of solicited and unsolicited messages.

For the sake of conciseness and readability, the term “transponder” will be used herein to describe any type of remote communications device capable of communicating with communications electronics. The remote communications device may include receivers and transmitters alone or in combination as well as transponder electronics adapted to respond and/or modify an original signal to provide a transmit signal. The preferred communications method includes radio frequencies used in RFID applications, but other RF, infrared, acoustic or other known remote communication methods may also be used in some embodiments. A transponder as defined herein may provide either unidirectional or bidirectional communications with fixed-location communications electronics and may be active or passive. Likewise, the fixed location communications electronics may also be referred to as “interrogator electronics.” Interrogator electronics will generally include a transmitter and a receiver capable of communicating with a transponder, and may be provided in the compact assembly or associated with the surface to which the assembly is attached.

Depending on the application, various numbers of antennas and antenna arrangements are possible. Certain embodiments of a compact antenna module in accordance with the present invention may comprise an array formed of multiple antennas. For example, a compact antenna module could have at least one dedicated antenna for receiving information from the transponder and at least one separate antenna for transmitting information to the transponder. Other embodiments may include the necessary switching or other electronics to allow a single antenna or set of antennas to both transmit and receive information to and from transponders. It is also contemplated that a compact antenna module having one or more antennas may operate in conjunction with one or more antennas outside of the module to form an alternative embodiment of an antenna array. For example, a compact antenna module attached to a surface could be operatively connected to an antenna located behind the surface to facilitate remote communications with multiple transponders at different frequencies.

Furthermore, as discussed in more detail below, some embodiments of a compact antenna module in accordance with the present invention may comprise parasitic tuning elements within the antenna module or associated with the surface to which the module is attached, or both. In other words, a compact antenna module having one or more antennas may also comprise one or more tuning elements to facilitate tuning and provide impedance matching. Alternatively, one or more tuning elements may be associated with the surface to which a compact antenna module is attached.

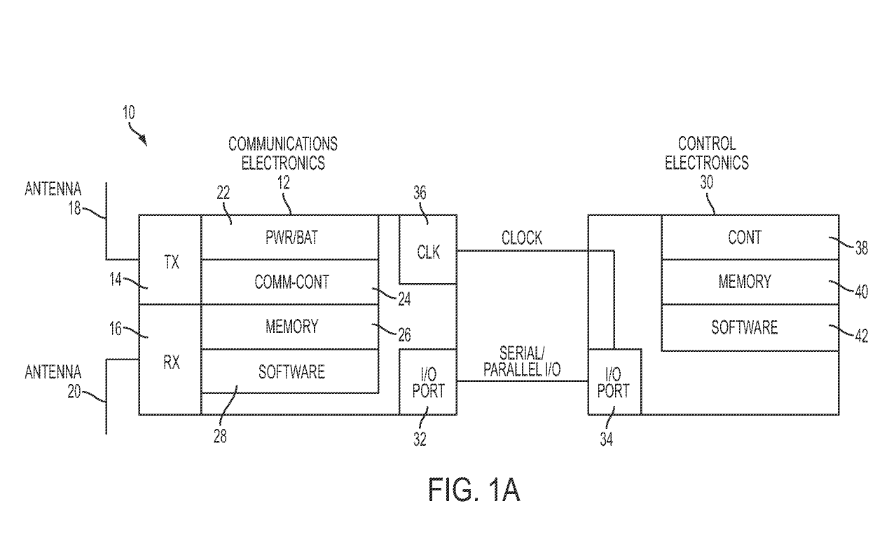

In this regard, FIG. 1A illustrates one embodiment of a transponder 10 in accordance with the present invention. Communications electronics 12, adapted to provide remote communications with various remote sources, includes a transmitter 14 and receiver 16 having associated antennas 18 and 20. Transmitter 14 and receiver 16 operate to transmit data from and receive data into the transponder 10. The antennas 18 and 20 may be any suitable type of antenna, including but not limited to a pole or slot antenna. Additionally, transponder 10 may operate with only one antenna. Communications electronics 12 may also include a power supply 22 and a communication controller 24 associated with a memory 26 having the software (e.g., firmware) 28 necessary to operate the communications electronics 12 and communicate with the control electronics 30. Power supply 22 may be a battery or an alternative energy storage unit that is charged by electromagnetic energy when the device is in the field of the interrogator signal.

Communications electronics 12 is capable of receiving remote communications signals through at least one of the antennas 18 and 20, and demodulating these signals. Serial communication between communications electronics 12 and control electronics 30 is provided via the input/output (I/O) ports 32 and 34 associated with the respective electronics. Communications electronics 12 provides a clock 36 to signal the I/O port 34 of the control electronics 30. Control electronics 30 may include a general controller 38, memory 40, and software 42 to provide remote processing. Memories 26 and 40 may include random access memory (RAM), read only memory (ROM), or a combination of both, as necessary or appropriate. Further, the memory may preferably be nonvolatile memory that stores information to be communicated to an interrogator.

Notably, communication controller 24 and general controller 38 may be integrated into one controller. Similarly, the software and memory of the communication and general control modules may be merged. Finally, control electronics 30 and the communications electronics 12 may be combined and may also include encryption hardware or software as necessary or desired. Further detail regarding the components of similar transponder devices is disclosed in commonly owned U.S. Pat. No. 6,313,737, entitled “Centralized Transponder Arbitration,” issued Nov. 6, 2001, the entire disclosure of which is incorporated herein by reference for all purposes.

As shown in FIG. 1B, the communications and general control electronics, as well as any associated controllers may be integrated into a single controller system and/or integrated circuit. In such cases, a single controller 44 is associated with memory 46 having any software 48 necessary or desirable for operation. In such an integrated system, controller 44 will carry out any control functions.

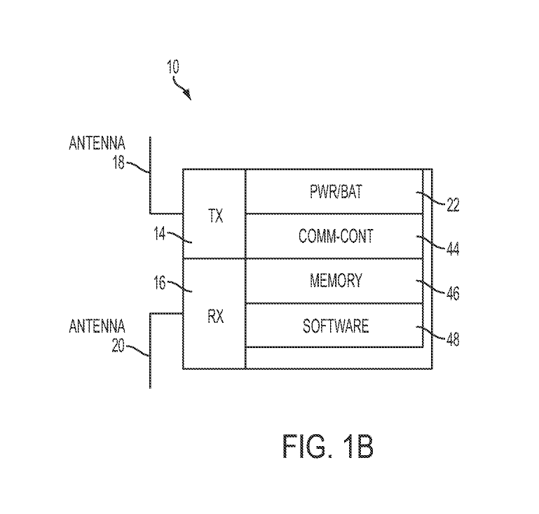

Some embodiments of the present invention are particularly suitable for use in remote transactions in a retail service station environment, and the below discussion will describe preferred embodiments in that context. However, those of skill in the art will understand that the present invention is not so limited. Referring now to FIG. 2, a remote transaction system, generally designated 50, typically is associated with three (3) subsystems: a remote communications unit such as transponder 10; a fuel dispenser 52 or other payment terminal; and a host network 54. In general, transponders 10 are adapted to communicate with and through the fuel dispenser 52 in order to obtain authorization for the transaction. Transponder 10 may also communicate with other local sources 56 directly. Various means of security may be employed depending on the information being communicated and the source and destination of the information. Thus, transponder 10, dispenser 52, and host 54 are preferably adapted to encrypt and decrypt certain communications therebetween. For additional detail relating to secure communications in a retail service station environment, attention is drawn to U.S. Pat. No. 6,078,888, entitled “Cryptography Security for Remote Dispenser Transactions,” issued Jun. 20, 2000, the entire disclosure of which is incorporated herein by reference for all purposes.

Transponder 10 is preferably integrated into a small carrying medium, such as a module mounted in or on a vehicle 58, a transaction card 60, or a key fob 62. Typically, transponder 10 may be in the form of a RF integrated circuit chip that is encapsulated with a hardened, non-conductive material, such as a plastic or epoxy, to protect it from the environment. Regardless of the carrying medium, transponder 10 is preferably designed to provide remote bidirectional communications with fuel dispenser 52. Preferably, fuel dispenser 52 is located in a fuel dispensing environment 64 so as to provide two fueling positions 66 on a corresponding fueling island 68. As one skilled in the art will appreciate, multiple fuel dispensers 52 may be provided at a respective fueling island 68. The dispensers are operatively associated with a station store 70. Store 70 may house a convenience store as well as one or more restaurants, a car wash, or other commercial establishment.

Generally, store 70 will include a site controller 72 to provide central control functions for the entire site including each dispenser 52. In preferred embodiments, site controller 72 may be part of the PASSPORT® point of sale (POS) system sold by Gilbarco Inc. of Greensboro, N.C., although third party site controllers may be used. Also, store 70 will typically comprise one or more POS devices 74 for processing individual customer transactions. Each dispenser 52 and POS device 74 is in electronic communication with central site controller 72 through a local area network (LAN), pump communication loop, or other suitable communication channel or line. Site controller 72 in turn may communicate with host network 54 via a remote network 76. Remote network 76 may be routed through the Public Switched Telephone Network, the Internet, both, or the like, as needed or desired.

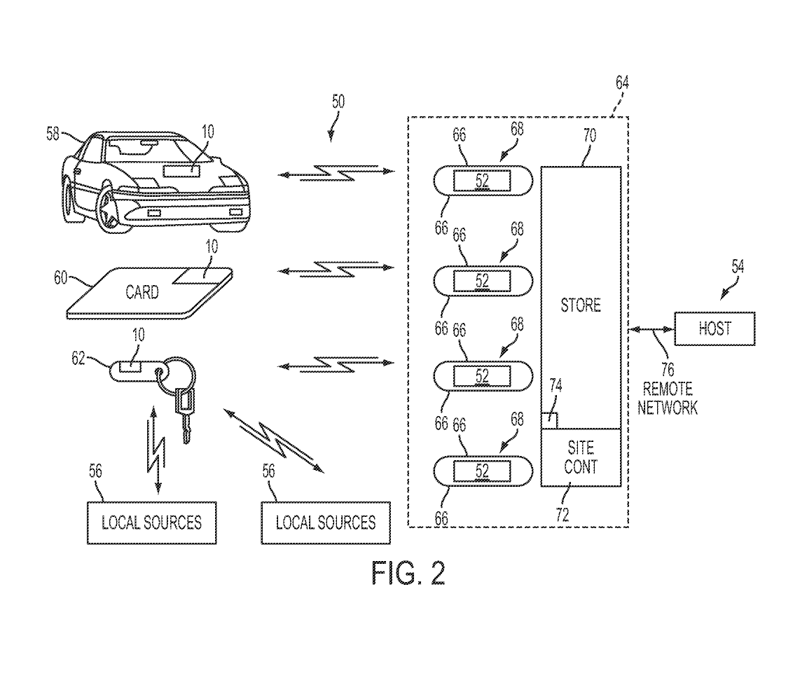

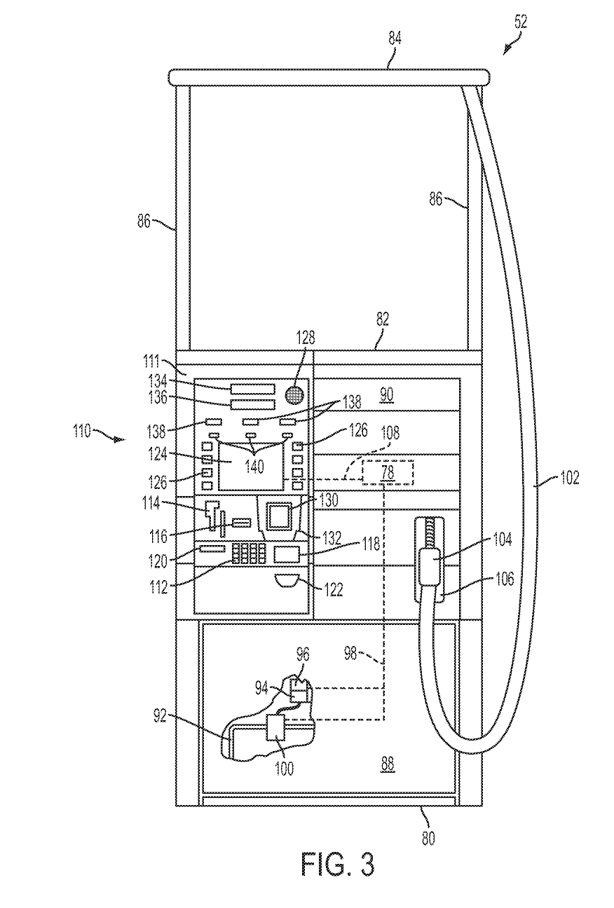

FIG. 3 illustrates a fuel dispenser 52 that operates in association with site controller 72 according to an embodiment of the present invention. Dispenser 52 includes a control system 78 having one or more controllers and associated memory 79 (see FIG. 4). The controllers may comprise any suitable microprocessor or other appropriate circuitry. Control system 78 is in operative communication with site controller 72. Control system 78 further controls various processes within the fuel dispenser 52 as described in more detail below.

In the illustrated embodiment, dispenser 52 has a base 80 and a top 82, with a canopy 84 supported by two side panels 86. Fuel dispenser 52 is subdivided into multiple compartments. A hydraulic area 88 encloses hydraulic components and an electronic area 90 encloses electronic components. A vapor barrier may be used to separate the hydraulic area 88 from the electronic area 90.

Several components used to control fuel flow may be housed within the hydraulic area 88. Fuel from underground storage tanks (USTs) is pumped through a piping network into inlet pipe 92. Fuel being dispensed passes though a meter 94, which is responsive to flow rate or volume. A pulser 96 is employed to generate a signal in response to fuel flow though the meter 94. Control/data lines 98 provide a signaling path from the pulser 96 to the control system 78, and provide signals to the control system 78 indicative of the flow of fuel being dispensed. Control/data lines 98 may provide control signaling to a valve 100 that may be opened and closed to permit or not permit dispensing of fuel.

Control system 78 includes a controller and control circuitry (see FIG. 4) for controlling functional processing within dispenser 52 by collecting meter flow measurements from the pulser 96. Control system 78 also typically performs calculations such as cost associated with a fuel dispensing transaction and may perform calculation operations associated with meter 94. Additionally, the control system 78 controls transactional processing at fuel dispenser 52 as will be described in more detail below.

As a dispensing transaction progresses, fuel is then delivered to a hose 102 and through a nozzle 104 into the customer's vehicle. Dispenser 52 includes a nozzle boot 106, which may be used to hold and retain nozzle 104 when not in use. Nozzle boot 106 may include a mechanical or electronic switch to indicate when nozzle 104 has been removed for a fuel dispensing request and when nozzle 104 has been replaced, signifying the end of a fueling transaction. A control line provides a signaling path from the electronic switch to control system 78. Control system 78 uses signaling received via the control line in order to make a determination as to when a transaction has been initiated or completed.

Control/data lines 108 provide electronic communication between control system 78 and a user interface 110. User interface 110 includes various combinations of subsystems to facilitate customer interaction with the dispenser 52. A bezel 111 acts as a lip around the various subsystems of interface 110. In most cases, bezel 111 is flush with the face of the fuel dispenser, however, in some embodiments it may extend outwardly from the face, in effect forming a raised lip. Bezel 111 may also comprise a plurality of sections that frame or house various subsystems or components.

As shown, user interface 110 may include a keypad 112. Keypad 112 may be used for selection of different types of purchase transactions available to the customer or to enter an authentication code. Keypad 112 may also be used for entry of a personal identification number (PIN) if the customer is using a debit card for payment of fuel or other goods or services.

User interface 110 may also include a magnetic strip card reader 114 for insertion of credit, debit, or other magnetic strip cards for payment. Additionally, the magnetic strip card reader 114 may accept loyalty or program-specific cards that entitle the customer to a fixed credit or percentage discount or other favorable pricing on fuel or other goods or services.

User interface 110 may also include other payment or transactional devices such as a bill acceptor 116 and a smart card reader 118. Other transactional devices, such as an optical reader and a biometric reader, are also contemplated. User interface 110 also typically includes a receipt printer 120 so that a receipt with a recording of the transaction carried out at the fuel dispenser 52 may be generated and presented to the customer. A change delivery device 122 may also be provided to deliver change to a customer for overpayment.

A display 124 is used to provide information, such as transaction-related prompts and advertising, to the customer. Soft keys 126 are used by the customer to respond to information requests presented to the user via the display 124. An intercom 128 may be provided to generate audible cues for the customer and to allow the customer to interact with an operator or attendant. Finally, as described in more detail below, user interface 110 may include a compact antenna module 130 for remote wireless communication with an RFID transponder associated with a customer. Module 130 may be located on the surface of dispenser 52 in any place that a small hole can be provided to receive a data connection, but in this example it is shown affixed to bezel section 132.

In addition, dispenser 52 includes a transaction price total display 134 that may be used to present the customer with the price to be charged to the customer for fuel that is dispensed. A transaction gallon total display 136 may be used to present the customer with the measurement of fuel dispensed in units of gallons or liters. Octane selection buttons 138 are provided for the customer to select which grade of fuel is to be dispensed before dispensing is initiated. Price per unit (PPU) displays 140 are provided to show the price per unit of fuel dispensed in either gallons or liters, depending on the programming of dispenser 52.

FIG. 4 is a diagrammatic representation of the dispenser electronics according to one embodiment of the present invention. As shown, control system 78 includes a controller and associated memory 79 to communicate with the site controller 72 through interface 142. Embodiments are contemplated in which control system 78 also communicates with POS devices 74 via an interface 144. Dispenser control system 78 is preferably comparable to the microprocessor-based control systems present in dispensers sold by Gilbarco Inc. under the trademark ENCORE®.

Dispenser control system 78 provides a graphical user interface with keypad 112 and display 124. Audio/video electronics 146 are adapted to interface with the dispenser control system 78 and/or an auxiliary audio/video source 148 to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store 70 while fueling the vehicle.

Preferably, the customer is provided a video menu at display 124 to facilitate selection of the various services, goods, and food available for purchase. Card reader 114 and bill acceptor 116 allow the customer to pay for any of the services, goods, or food ordered at the dispenser while the printer 120 will provide a written record of the transaction. Additionally, control system 78 is operatively associated with compact antenna module 130, which includes a receiver 150 and a transmitter 152, to communicate wirelessly with transponder 10. Thus, for example, control system 78 may facilitate wireless payment for goods and services by a customer using a transponder 10 or perform other remote transaction functions. Receiver 150 and transmitter 152 typically each have one or more antennas 154 associated therewith. A compact antenna module in accordance with the present invention is described in greater detail below.

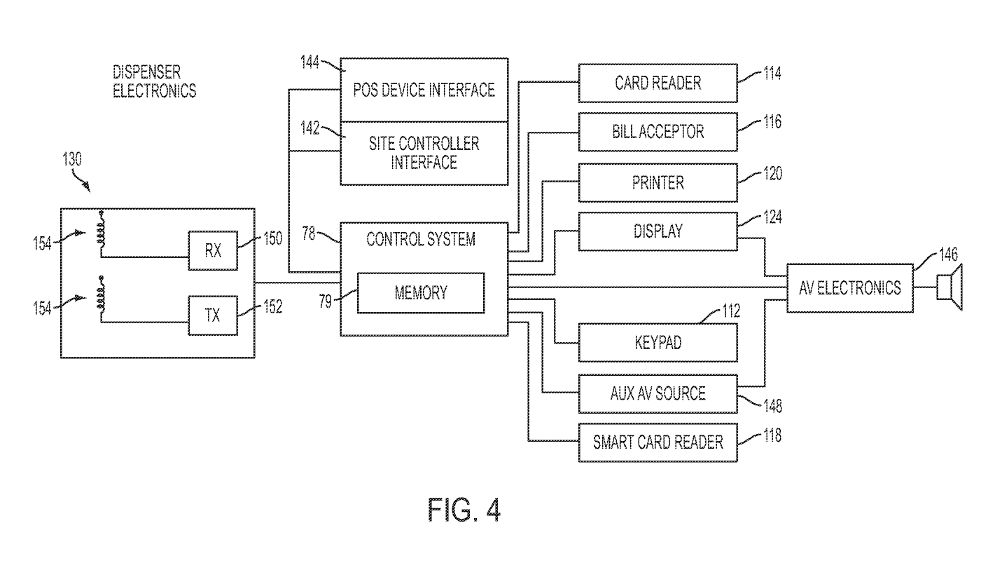

FIG. 5A shows a detailed view of a front panel of a fuel dispenser bezel 160 containing a prior art remote transaction system 162. An example of remote transaction system 162 may be the E-CIM unit sold by Gilbarco Inc. of Greensboro, N.C., which is an RFID system comprising two (2) antennas. Generally, dispenser bezel 160 defines a reader window 164 that is adjacent to other payment or transactional devices such as magnetic strip card reader 166 and keypad 168. Front panel 170 encloses reader window 164 and displays indicia 172 that indicates to a user that a transponder 174 can be read at window 164.

Additionally, FIG. 5B provides a detailed view of the prior art remote transaction system 162 when viewed from the interior of the fuel dispenser. In the illustrated example, system 162 comprises first and second antennas 176 and 178, respectively, which each send and receive signals for different systems. Antennas 176 and 178 are separated by spacer 180. Notably, the tight dimensional constraints of bezel 160 require first antenna 176 to be set back from the front of reader window 164 by approximately ⅜″, which can result in a substantial reduction in read range. System 162 also includes circuit board 182 carrying electronics adapted to operate system 162 and communicate with a dispenser control system via data connection 184.

In one example of operation, when the transponder 174 is placed near front panel 170, the electromagnetic field emitted by antenna 176 energizes transponder 174, allowing transponder 174 to respond with an RF signal carrying information. Antenna 176 receives the responsive signal, which is demodulated at circuit board 182. Circuit board 182 transmits the resulting information via data connection 184 to communications electronics in a control system of the fuel dispenser and/or to a site controller.

A dispenser using this prior art remote transaction system needs to be customized at the time of manufacture to create the window in the bezel. Because the antennas and circuitry are mounted within the fuel dispenser enclosure, the antennas' effective read range is reduced by approximately the distance they are set back from the reader window plus the thickness of the front panel. Further, the relatively large window required in the dispenser bezel could allow a leak path into the dispenser for water and other environmental elements such as dust, pollutants, and chemical cleaners.

Finally, the antennas' ability to send and receive RF signals can be affected by the presence of metal or other objects in the near-field zone around the antennas. When a typical remote transaction system is mounted near such metallic objects, the object(s) may change characteristics of the antenna (possibly including detuning of the resonant frequency, altering the bandwidth, and altering impedance).

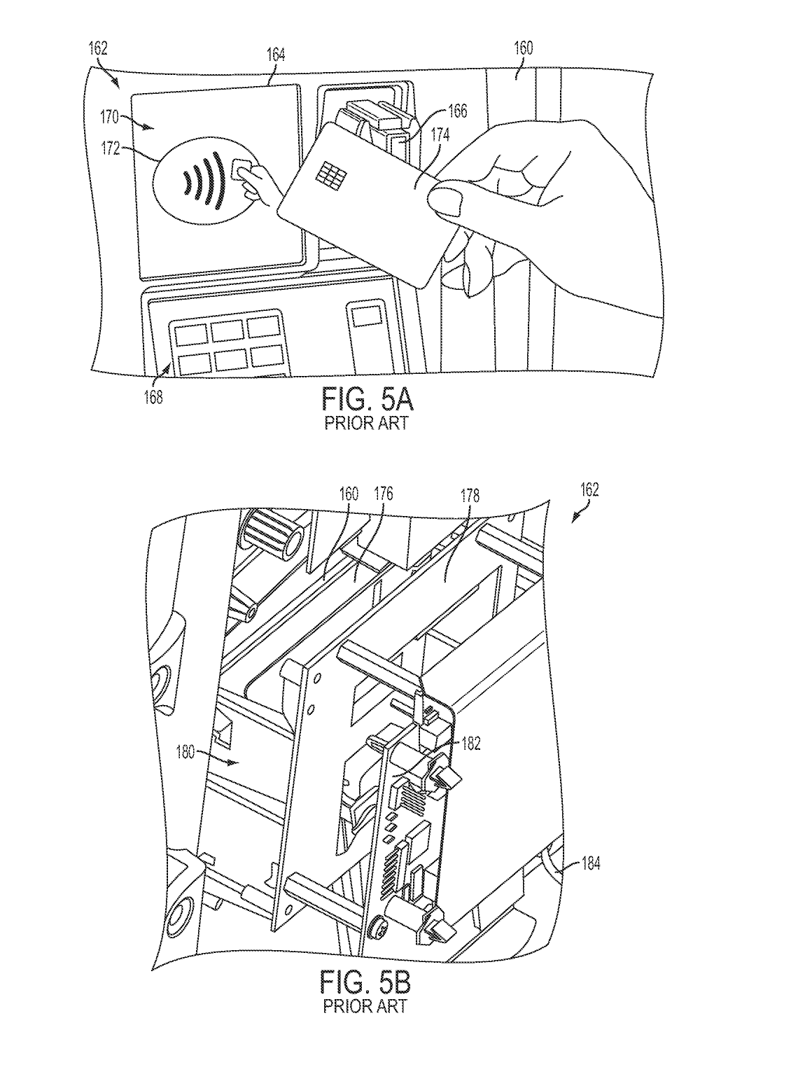

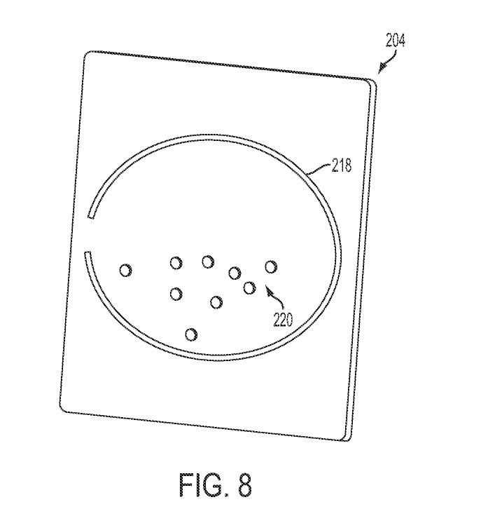

FIG. 6 shows a compact antenna module 200 in accordance with one embodiment of the present invention. Antenna module 200 comprises a front cover 202 attached to a substrate 204. Substrate 204 carries certain elements which are in communication with interrogator electronics 206 (FIG. 9) needed to receive and process remote communications signals. As discussed in more detail below, interrogator electronics 206 may be housed in electronics unit 208.

Front cover 202 may preferably be formed from a relatively thin layer of a nonconductive plastic material, such as mylar. In the illustrated example, front cover 202 and substrate 204 are generally rectangular in shape, but those skilled in the art will realize that these elements can take many shapes depending on the needs of a particular application. The cover and substrate layers may be attached using any suitable affixation technique, such as adhesive.

Front cover 202 includes graphics 210 to display informational, transactional, advertising, or promotional information. For example, informational graphics may direct a customer where and when to place a transponder near the module for reading. In some embodiments, as discussed below, graphics 210 may be backlighted by a plurality of light-emitting diodes (LEDs) mounted in association with substrate 204. Further, in some embodiments, graphics 210 may comprise an electrophoretic display. An electrophoretic display is an aesthetically-pleasing information display that uses an applied electric field to form visible images by rearranging charged pigment particles. Examples of commercial embodiments include the high-resolution active matrix displays used in “e-readers” such as the Amazon Kindle. Such displays may be constructed from an electrophoretic imaging film similar to that manufactured by the E Ink Corporation of Cambridge, Mass.

In the illustrated embodiment, a rectangular adhesive layer 212 is attached to the back of the substrate 204 for adhering the module 200 to a surface. As can be seen, the electronics unit 208 defines a smaller “footprint” than the front cover 202 and plastic substrate 204 in this embodiment. Thus, a portion of the substrate will extend beyond electronics unit 208 to provide a flange for adhesive layer 212. This allows the module 200 to fit into a recess in a surface so that front cover 202 is approximately flush with the surface while the electronics unit 208 is received in the recess (see, e.g., module 130 in bezel 111 in FIG. 3). However, embodiments are contemplated in which an adhesive layer 212 is attached directly to electronics unit 208. Also, those of skill in the art will understand that the module 200 can be attached to a surface by other suitable means, such as hardware fasteners.

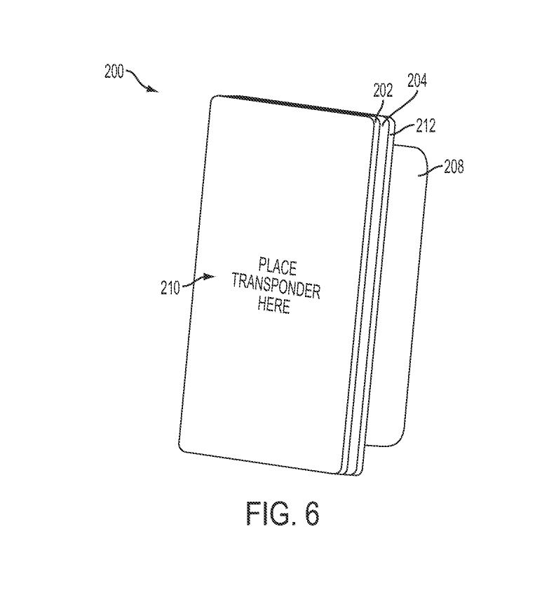

Referring now to FIG. 7, additional details about electronics unit 208 can be seen. Here, electronics unit 208 comprises a molded plastic container that houses interrogator electronics 206. In particular, interrogator electronics 206 may be embedded in a potting compound to provide stability and environmental protection. However, electronics unit 208 may not be necessary in some embodiments of module 200, and many other configurations of interrogator electronics 206 are contemplated. For example, and not by way of limitation, one or more of the components of interrogator electronics 206 may be located on, within, or behind the surface to which antenna module 200 is mounted. In this regard, interrogator electronics 206 may be located remote from antenna module 200 but still in electronic communication with the one or more antennas and other electronic components of antenna module 200. Or interrogator electronics 206 may comprise a flexible circuit board (e.g., a flexible plastic substrate such as polyimide) attached to substrate 204. Those of skill in the art will appreciate that many configurations of interrogator electronics 206 fall within the scope of the present invention.

In the illustrated example, however, electronics unit 208 has a back portion 214 exposing a data connection 216 in electronic communication with interrogator electronics 206. Data connection 216 will typically penetrate back portion 214 so that it can be received in a small hole defined in the mounting surface. Further, after antenna module 200 is affixed to the surface, data connection 216 is communicatively associated with a control system or remote network for processing signals received from the transponder. In the illustrated embodiment, data connection 216 is a rectangular plug that mates with an appropriate connector inside the dispenser housing. Those skilled in the art will realize, however, that connection 216 may be any type of connection suitable for data transfer, including wireless data transfer.

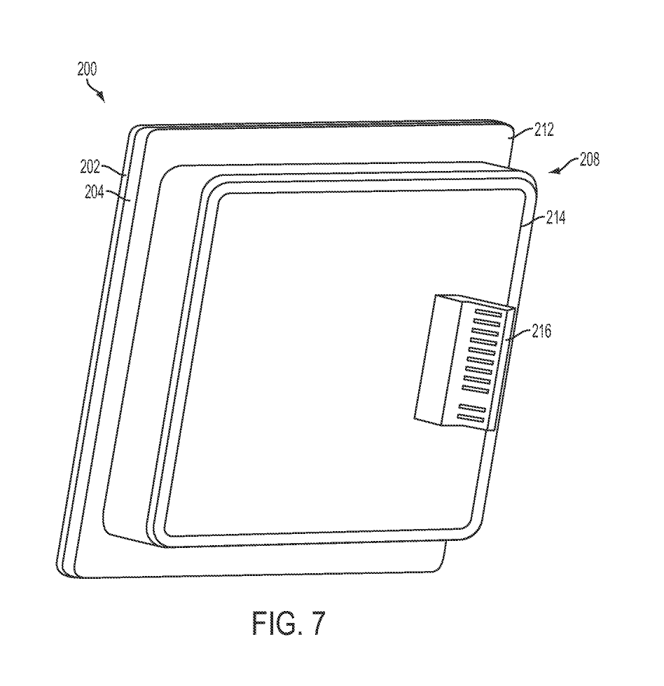

As shown in FIG. 8, substrate 204 includes an antenna 218 and a plurality of LEDs 220 in this embodiment. Substrate 204 is preferably formed of a suitable dielectric material. Those skilled in the art are aware that the choice of material for substrate 204 may depend on the environment in which antenna module 200 is used. For example, in a retail service station environment, substrate 204 may need to be resistant to degradation in the presence of petroleum products.

Antenna 218, which is in electronic communication with interrogator electronics 206, is preferably a conductive metallic structure. Antenna 218 may be constructed of any suitable antenna material depending on the environment in which it is used, including, but not limited to, copper, aluminum, and silver. The antenna may be formed as a discrete element or may be formed using deposition or circuit board techniques. In an outdoor setting, aluminum may be preferable due to its corrosion-resistant properties. Moreover, antenna 218 is illustrated as a loop antenna but antennas other than those having an elliptical or loop formation are also contemplated. In this regard, antenna 218 may comprise any suitable type of antenna, such as a dipole, wire, or slot antenna. Indeed, the particular type of antenna will depend on the operating parameters of the RFID system.

LEDs 220 may be mounted in substrate 204 to provide backlighting for graphics 210 on the front cover 202. One skilled in the art will appreciate that LEDs 220 are in electrical communication with appropriate circuitry in interrogator electronics 206. They may be configured to form a particular pattern, such as the outline of a business logo, and may also be configured to illuminate graphics 210 and/or front cover 202 upon certain conditions. For example, LEDs 220 may light up when a customer has placed a transponder near compact antenna module 200 to indicate a successful “read” of information by the module. As another example, the lights may be configured to illuminate during the payment stage of a fueling transaction to visually indicate to a customer that the module 200 is ready and waiting to receive an RF signal from the customer's transponder. Many other configurations are possible both to provide visual and informational cues to a user.

FIG. 9 is a perspective view of adhesive layer 212. Adhesive layer 212 is preferably a flexible strip of material used to effect a substantially air- and water-tight seal between compact antenna module 200 and a surface. Adhesive layer 212 may comprise a layer of double-sided tape having adhesive on both sides, or it may be formed of any material that is deformable to seal module 200 tightly to an enclosure, such as gasket paper, rubber, silicone, a plastic polymer or the like. Adhesive layer 212 preferably has the same peripheral dimensions as substrate 204 and has a large aperture 222 formed at its center. Electronics unit 208 is received in aperture 222.

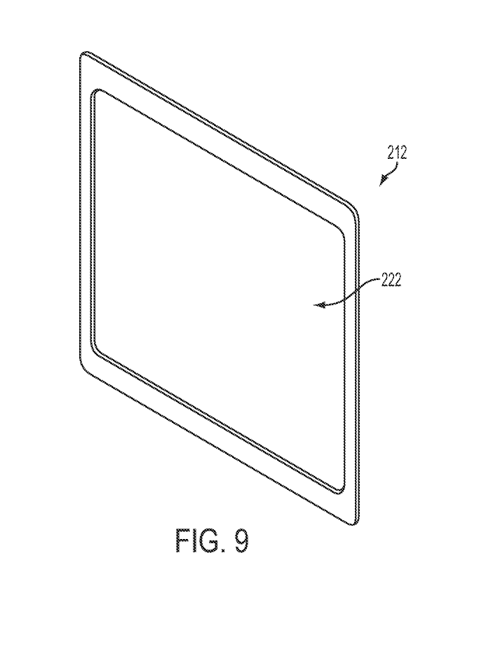

The assembly of one embodiment of compact antenna module 200 will be described with reference to FIG. 10. In this embodiment, the compact antenna module 200 is assembled by first attaching front cover 202 having graphics 210 to the front side of substrate 204, which has antenna 218 and LEDs 220 mounted therein. Next, electronics unit 208 having data connection 216 is attached to the center of the back side of substrate 204. Finally, adhesive layer 212 is received around electronics unit 208 and affixed to the resulting flange on the back side of substrate 204.

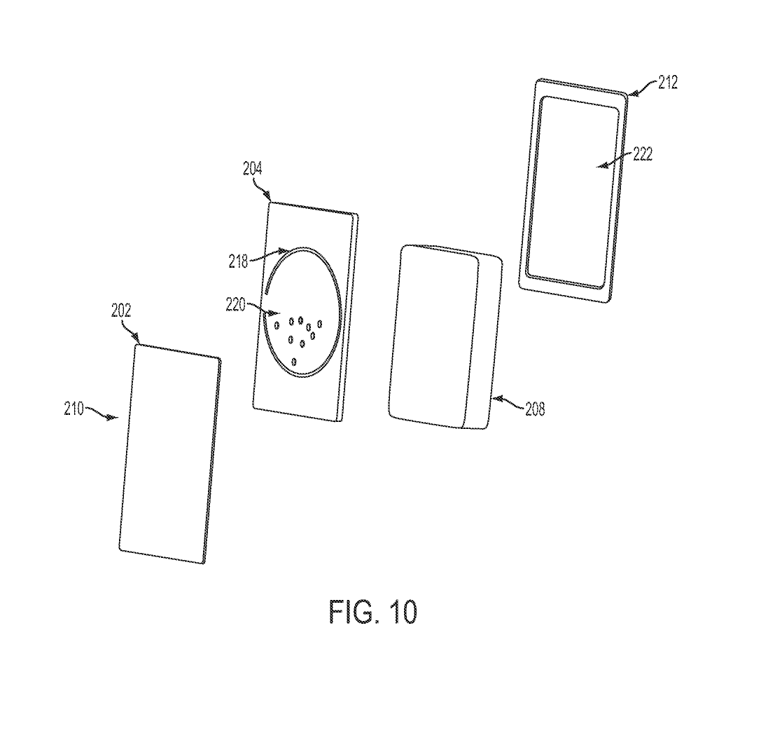

FIG. 11 is a diagrammatic representation of interrogator electronics 206 in accordance with an embodiment of the present invention. Here, the exemplary components of electronics 206 are shown enclosed in the container of electronics unit 208, represented by a broken line. As noted above, however, one or more of the components may be located remotely from compact antenna module 200, as needed or desired. Indeed, in some embodiments, interrogator electronics 206 themselves may be mounted external to module 200. Interrogator electronics 206 includes receiver 224 and transmitter 226, both of which are in electronic communication with antenna 218. (Note that in many embodiments the interrogator electronics may be in electronic communication with more than one antenna in more than one substrate.) Generally, transmitter 226 and receiver 224 operate to transmit to and receive from a transponder. Interrogator electronics 206 may also comprise automatic gain control (AGC) electronics 228 to amplify a signal received from a tag to a normalized level to ensure proper reception and demodulation at receiver 224.

Interrogator electronics 206 may also include communications electronics 230. In this embodiment, communications electronics 230 comprise a communications controller 232 associated with a memory 234 having software 236 necessary to operate interrogator electronics 206 and communicate with a control system 238 via data connection 216. Memory 234 may include RAM, ROM, or a combination of both, as necessary or desired. Control system 238 is preferably analogous to control system 78 discussed above.

Interrogator electronics 206 may also contain audiovisual (A/V) electronics 240. In this embodiment, A/V electronics 240 may comprise LED electronics 242 and annunciator electronics 244. LED electronics 242 is configured to illuminate the LEDs 220 on substrate 204 upon certain conditions as discussed above. Annunciator electronics 244 is preferably configured to operate one or more annunciators that may be in compact antenna module 200 to provide audible signals to a user that has presented a transponder. As noted above, A/V electronics 240 need not be mounted in electronics unit 208 and may be mounted in association with the remote control system 238 in an enclosure. Those skilled in the art will appreciate that in an embodiment where graphics 210 comprise an electrophoretic display, LED electronics 242 may be replaced with electronics suitable to operate the electrophoretic display.

As noted above, metallic components near an antenna may affect an antenna's impedance and cause de-tuning. For example, an antenna mounted on a bezel of a fuel dispenser may need to be compensated for the effect of the fuel dispenser's metal chassis on the antenna's tuning. In this regard, interrogator electronics 206 may include a suitable impedance matching network 246 to provide impedance matching for a particular operating frequency. In this regard, matching network 246 may be an integrated circuit formed using surface-mount technology (SMT) or strip line techniques. Typically, one or more capacitors and inductors will be provided. Additional information on impedance matching between a wireless communication device and an antenna is disclosed in U.S. Pat. No. 6,628,237 entitled “Remote Communication Using Slot Antenna,” issued Sep. 30, 2003, the entire disclosure of which is incorporated herein by reference for all purposes.

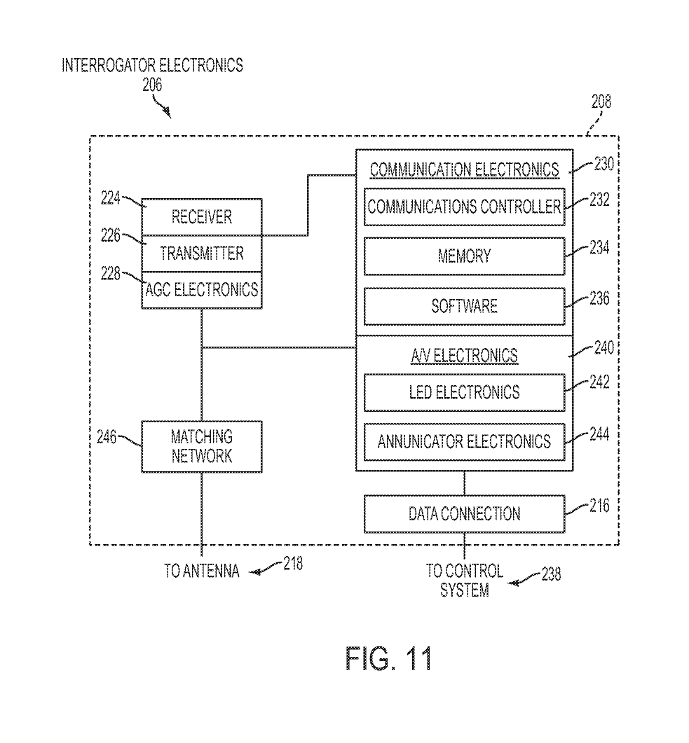

FIG. 12A shows a front perspective view of the compact antenna module 200 of FIG. 6 mounted in a bezel section 248 in accordance with an embodiment of the present invention. Bezel section 248 is preferably formed of a hardened, nonconductive plastic or other rigid material appropriate for a fueling environment. When antenna module 200 is mounted to a nonmetallic bezel section, antenna performance generally improves because of added separation from any metallic and electronic components that may be located in the area behind bezel section 248. Bezel section 248 is preferably configured such that a recess 250 is formed therein. Because the electronics unit 208 exhibits a smaller footprint than the front cover 202 and substrate 204 in the presently described example, module 200 may be configured to seat into recess 250.

Bezel section 248 can be a separate piece mounted to the surface of an enclosure such as bezel 111 of fuel dispenser 52 or it can be formed as an integral part of bezel 111. In either case, bezel section 248 can be configured such that the front cover 202 of antenna module 200 is approximately flush with the enclosure's surface when electronics unit 208 is received in the recess 250 (see, e.g., module 130 in bezel section 132 in FIG. 3). Referring now also to FIG. 12B, in some embodiments, data connection 216 may penetrate a slot 252 in the back side of recess 250 of bezel section 248. In this embodiment, bosses 254, which define threaded bores, are integrally formed with the back surface of bezel section 248 to facilitate attachment of the bezel 248 to the enclosure with suitable fasteners. In one example, after a desired location on the dispenser 52 for mounting bezel section 248 is selected, a small hole could be formed in the bezel 111 big enough only to receive data connection 216. Thereby, data connection 216 (and thus the interrogator electronics 206) could be connected to the control system 78 and/or to a POS device 74. It will be clear to those skilled in the art that this configuration minimizes leak paths for water and other environmental contaminants. Moreover, the external mounting of module 200 increases the read range of one or more antennas within module 200 and allows efficient mounting and enclosure design.

Sophisticated remote transaction systems may employ a plurality of antennas that may operate at different frequencies. These antennas may receive and transmit signals carrying different types of information and may be configured to interact with more than one type of remote communications unit. Thus, in some embodiments of the present invention it may be desirable to use a compact antenna module in conjunction with one or more antennas mounted on, within, or behind the surface to which the antenna module is attached to create an antenna array. Attaching a compact antenna module to a surface generally increases the read range of one or more antennas in the module (in comparison with an antenna mounted inside the dispenser). However, other antennas with greater ranges or operating at different frequencies may be on or behind the mounting surface for various functional or aesthetic reasons.

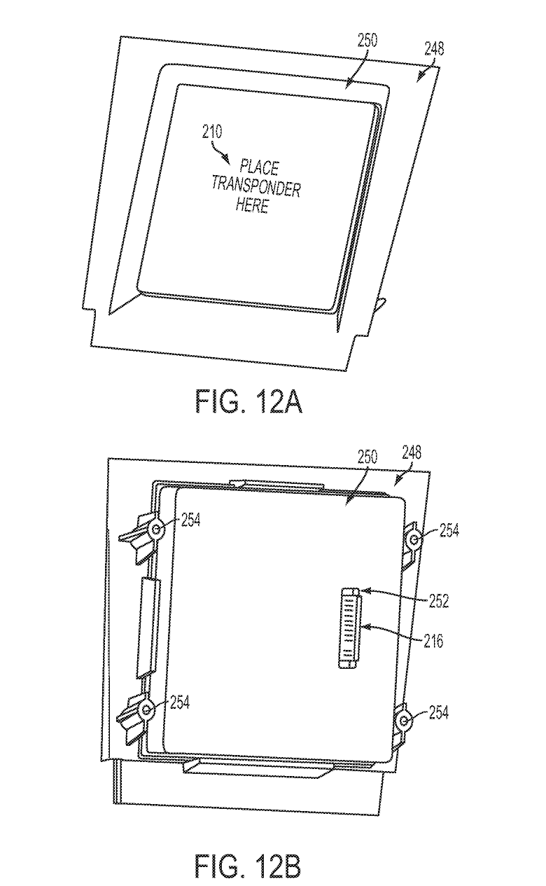

Therefore, FIG. 13 illustrates an antenna array comprising a compact antenna module 300 attached to an exterior surface 302 of an enclosure 304 which has two antennas 306 and 308 mounted in its interior according to one embodiment of the present invention. In this embodiment, module 300 is preferably analogous to module 200, described above. Module 300 and antennas 306 and 308, which are received on suitable mounting hardware 310, form an antenna array. Further, module 300 and antennas 306 and 308 are in electronic communication with suitable interrogator electronics to enable remote communication between the array and one or more transponders operating at different frequencies. As explained in more detail below, in alternative embodiments one or more tuning elements may be provided in module 300 or on mounting hardware 310 to tune the antennas.

Furthermore, it may be desirable to provide parasitic tuning elements in conjunction with a compact antenna module or compact antenna array of the present invention. Specifically, one or more antennas may be interchangeable with parasitic elements, such as tuning rings, so that the remote transaction system may compensate for the omission of an antenna from an array. Those skilled in antenna design are familiar with parasitic elements and the effect such elements can have when used in conjunction with one or more antennas. Generally, adding a parasitic element to an antenna assembly will alter the resonant characteristics of an antenna located near the parasitic element. Thus, parasitic elements are often used to tune antennas in remote communications devices to a desired resonant frequency, provide impedance matching, and add directional gain to antennas. Further, the shape and material of parasitic elements affect tuning, so these characteristics will vary according to the configuration and desired operating frequency of an antenna or antenna array.

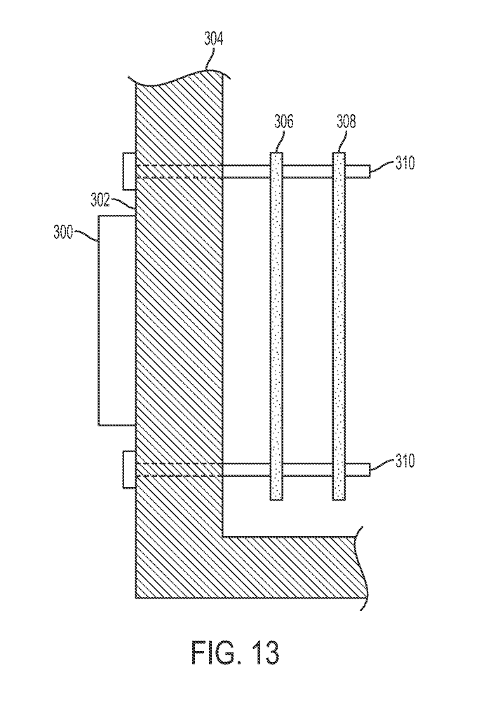

In this regard, FIGS. 14A and 14B provide alternate examples of tuning rings 312 and 314 that may be used in certain embodiments of the present invention. Tuning rings 312 and 314 are preferably annular structures formed of a conductive material such as metal or a conductive polymer. FIG. 14A shows a plan view of tuning ring 312 having a slot 316, which may be provided to alter the resonant characteristics of tuning ring 312. In particular, those of skill in the art will appreciate that slot 316 adds a capacitive element in series with the inductance of the ring, which affects the frequency at which resonance occurs. This may be desirable because it removes most of the loading below the resonant frequency. The width W of slot 316 will vary according to the desired resonant characteristics. As needed or desired to achieve optimal performance, however, tuning ring 314 may be formed without a slot as shown in FIG. 14B.

In some circumstances, a user may desire an antenna array that may operate in multiple configurations without having to retune one or more antennas when the configuration is changed, such as by removing an unneeded antenna. In such a case, one or more tuning elements may replace an unused antenna in an antenna array to compensate for impedance mismatches that would otherwise occur.

For example, a user may wish to construct a system having either or both of a first and second RF subsystem. Thus, where the system comprises both RF subsystems, a first and second antenna may be provided in an antenna array; where the system only comprises one of either the first or second subsystem, the respective unused antenna may be removed from the array. In the latter case, a parasitic tuning element is substituted for the unused antenna. Thus, the system will remain in tune in any of the three possible configurations in this example. This is the case even where the first and second antenna have widely different carrier frequencies. Those of skill in the art will also appreciate that the above-described embodiment may facilitate manufacture and distribution of antennas, as only a single stock keeping unit (SKU) may be used for each antenna, regardless of configuration.

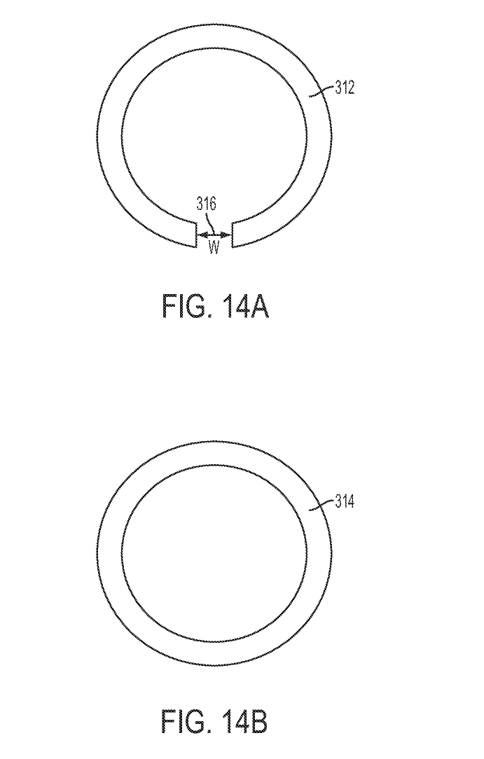

In this regard, FIG. 15 diagrammatically illustrates compact antenna module 300 affixed to a surface of an enclosure according to an embodiment of the present invention. Here, module 300 is attached to the exterior surface 318 of enclosure 320. Tuning ring 312 is mounted internal to the enclosure 320 to facilitate tuning of the remote transaction system. Enclosure 320 may preferably be a suitable bezel on the front of a fuel dispenser. In this example, tuning ring 312 is mounted using suitable mounting hardware 322. Tuning ring 312 is set a selected distance D from antenna module 300 according to the desired operating characteristics. Further, interrogator electronics 324, which are preferably analogous to interrogator electronics 206, on circuit board 326 are also received on mounting hardware 322. Thus, in contrast to the above example, here interrogator electronics 324 are located inside of enclosure 320. A cover 328, preferably formed of molded plastic, may also be received on mounting hardware 322 to surround and protect interrogator electronics 324. In this regard, interrogator electronics 324 may be potted in the cover.

Moreover, in other embodiments it may be desirable to provide an antenna array comprising a plurality of antennas in a compact antenna module to transmit and receive signals of various frequencies. For example, three different transponders may operate at carrier frequencies of 134 kHz, 13.56 MHz, and 433 MHz, respectively, and the array may comprise three antennas tuned to resonate at the respective frequencies. Additionally, transponders may receive signals at a first frequency and transmit signals to the array at a second frequency.

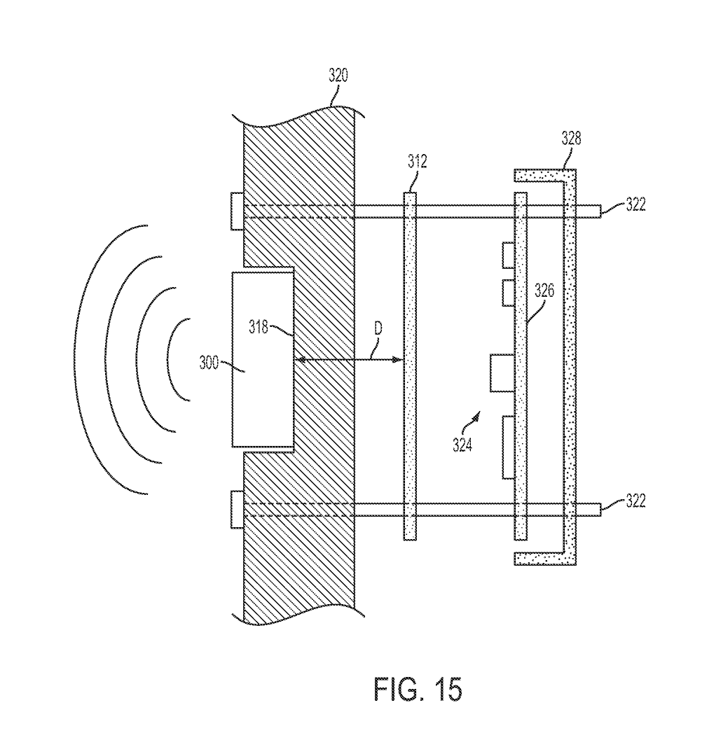

In this regard, FIG. 16 illustrates a compact antenna module 400 comprising a multi-layer antenna array 402 according to an embodiment of the present invention. Module 400 may preferably be constructed similarly to compact antenna module 200, but with array 402 substituted for substrate 204. Array 402 comprises four layers 404, 406, 408, and 410 in this example. Layers 404-410 are preferably formed of a suitable dielectric material in a fashion similar to substrate 204 described above. In this example, array 402 comprises two antennas configured to resonate at different frequencies as described in more detail below.

Module 400 comprises a front cover 412 attached to the front of first layer 404 of array 402. An adhesive layer 414 is attached to the rear of fourth layer 410 of array 402. Module 400 also includes interrogator electronics mounted in electronics unit 416. The interrogator electronics are in electronic communication with a remotely located control system 418 via data connection 420. The interrogator electronics are preferably similar to the above-described interrogator electronics 206 but are adapted to send and receive remote communications signals through and tune a plurality of antennas. Front cover 412, adhesive layer 414, electronics unit 416, control system 418, and data connection 420 are preferably analogous to front cover 202, adhesive layer 212, electronics unit 208, control system 78, and data connection 216, respectively. It can thus be seen that module 400 is compact while still facilitating wireless communication between the control system 418 and one or more transponders.

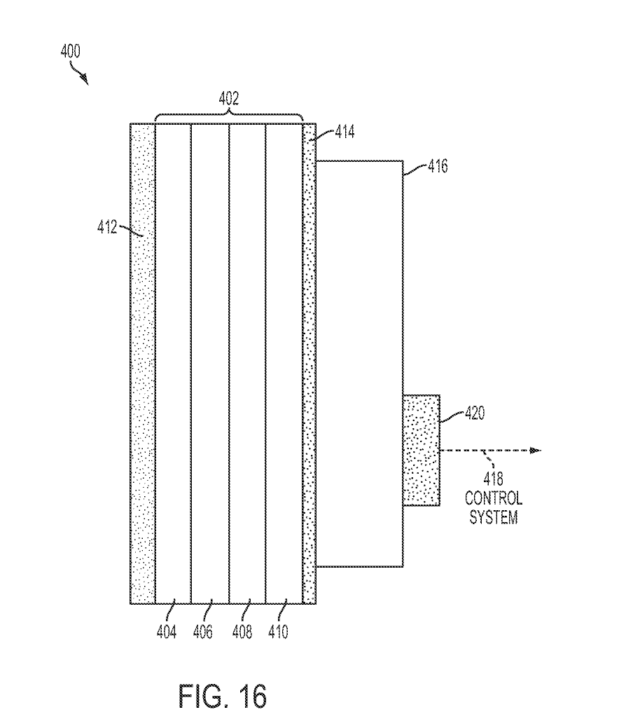

FIG. 17 is an exploded perspective view of the multi-layer antenna array 402 of FIG. 16 in accordance with an embodiment of the present invention. In the illustrated example, array 402 comprises a low frequency antenna 422 and a high frequency antenna 424. Low frequency antenna 422 is located in second layer 406 and fourth layer 410. Antenna 422 comprises a suitable number of turns of a conductive metallic structure arranged in a square shape. High frequency antenna 424 is located in third layer 408, and comprises a suitable number of turns of a conductive metallic structure arranged in an elliptical shape. As noted above, however, the particular types of antennas, the material of which they are made, and their arrangements in each layer will depend on the desired characteristics of the antenna. Antennas 422 and 424 are in electronic communication with the interrogator electronics.

Further, in this example first layer 404 comprises an electric shield 426. Shield 426, which may preferably be grounded, acts as a Faraday shield between antennas 422, 424. Those of skill in the art will appreciate that shield 426 helps minimize interference between the antennas in that shield 426 acts as a capacitive path to ground for signals to and from antennas 422, 424. Shield 426 is preferably arranged in first layer 404 concentrically with respect to high frequency antenna 424 in third layer 408.

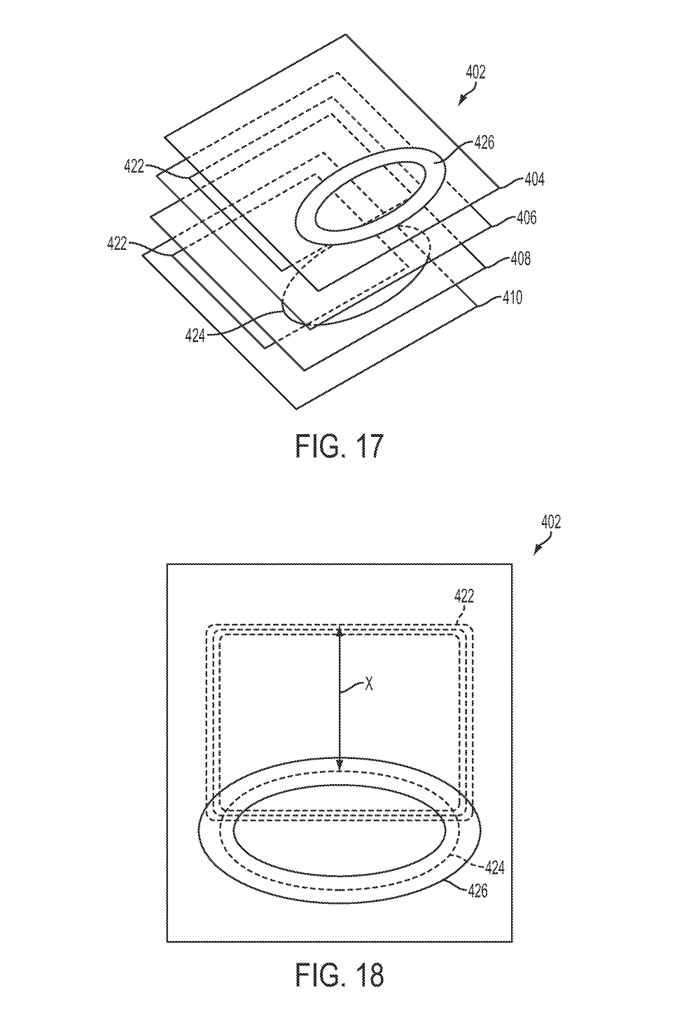

Referring now to FIG. 18, those skilled in the art will appreciate that the configuration of antennas 422 and 424 relative to one another will depend on the desired application and operating frequencies. Thus, antennas 422 and 424 may be concentrically arranged (i.e., one directly above the other) or they may be offset in their respective planes along the longitudinal dimension of array 402. For example, in FIG. 18 antennas 422 and 424 are offset by a selected distance X which is the appropriate offset to operate with minimal electromagnetic interference.

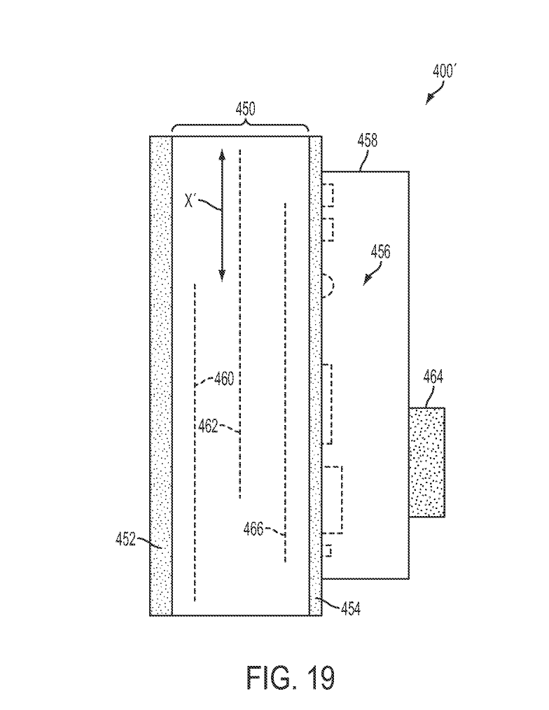

Furthermore, it may be desirable to provide parasitic tuning elements in conjunction with a compact antenna array of the present invention. In this regard, FIG. 19 shows a side view of a compact antenna module 400′ comprising a multi-layer antenna array 450 according to an embodiment of the present invention. Similar to modules 200, 300, and 400 discussed above, module 400′ also comprises a front cover 452 and an adhesive layer 454. Module 400′ further includes suitable interrogator electronics 456 provided in electronics unit 458 to facilitate remote communications between a transponder and antennas 460 and 462. The interrogator electronics 456 may preferably be in electronic communication with a remotely located control system via data connection 464.

The two antennas 460 and 462 may be offset by a distance X′ to minimize electromagnetic interference. Because a third antenna is not necessary in this example, FIG. 19 also shows that multi-layer array 400′ further comprises a tuning element 466. Although one tuning element is shown in the illustrated example, those skilled in the art will understand that multiple tuning elements may be provided in array 450 as needed.

Tuning element 466 is formed of conductive material such as metal or a conductive polymer, and is shaped facilitate tuning as discussed above. Further, the placement of tuning element 466 relative to antennas 460 and 462 will be selected by those skilled in the art to optimize the resonant characteristics of antennas 460 and 462. Tuning element 466 thus tunes antennas 460 and 462 to the desired resonant frequency and compensates for impedance mismatches.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A remote transaction system, comprising:
a compact assembly adapted to be attached to a surface, wherein said compact assembly comprises at least one antenna; and
communications electronics adapted to receive a remote communications signal from at least one remote communications device using said at least one antenna,
wherein said communications electronics are further adapted to extract identification information from said remote communications signal and provide identification information to a control system.

2. The remote transaction system of claim 1, wherein said at least one antenna comprises at least two antennas operating at different frequencies.

3. The remote transaction system of claim 1, wherein said at least one antenna comprises a first antenna and a second antenna, said first and second antennas operating at different frequencies.

4. The remote transaction system of claim 3, wherein said first and second antennas are interposed in different layers of said compact assembly.

5. The remote transaction system of claim 3, wherein said communications electronics are further adapted to receive a remote communications signal from a communications device using said first antenna and transmit a communications signal to said communications device using said second antenna.

6. The remote transaction system of claim 1, wherein said communications electronics are further adapted to receive a remote communications signal from at least one communications device using an antenna separate from said compact assembly.

7. The remote transaction system of claim 1, wherein said at least one antenna comprises a loop antenna.

8. The remote transaction system of claim 1, further comprising at least one tuning element interposed in a layer of said compact assembly.

9. The remote transaction system of claim 8, wherein said at least one tuning element is a tuning ring.

10. The remote transaction system of claim 1, wherein said compact assembly has a flange and an electronics housing.

11. The remote transaction system of claim 10, wherein said communications electronics are potted in said electronics housing.

12. The remote transaction system of claim 1, wherein said communications electronics comprises a flexible circuit board.

13. The remote transaction system of claim 1, wherein said communications electronics comprises an impedance matching network.

14. The remote transaction system of claim 1, wherein said surface is a bezel of a fuel dispenser.

15. The remote transaction system of claim 1, said compact assembly further comprising a front cover formed of a nonconductive plastic material.

16. The remote transaction system of claim 15, wherein said front cover is backlighted by a plurality of light-emitting diodes.

17. The remote transaction system of claim 1, wherein said compact assembly includes an electrophoretic display.

18. An antenna array, comprising:
a first antenna arrangement comprising at least one antenna located in a compact assembly, wherein said compact assembly is adapted to be attached to a surface;
communications electronics adapted to wirelessly communicate with at least one remote communications device using said first antenna arrangement; and
a control system in electronic communication with said communications electronics adapted to process wireless communications received by said communications electronics.

19. The antenna array of claim 18, further comprising a second antenna arrangement separate from said compact assembly and coupled to said surface.

20. The antenna array of claim 19, wherein said second antenna arrangement comprises at least one antenna and said communications electronics are further adapted to communicate wirelessly with said at least one remote communications device using said second antenna arrangement.

21. The antenna array of claim 19, wherein said communications electronics are further adapted to communicate wirelessly with at least one remote communications device that is different than said at least one remote communications device using said second antenna arrangement.

22. The antenna array of claim 19, wherein said second antenna arrangement comprises a tuning element.

23. The antenna array of claim 18, wherein said surface is the exterior surface of a fuel dispenser housing.

24. A fuel dispenser, comprising:
a fuel dispenser housing;
a control system;
a compact assembly mounted to an exterior surface of said fuel dispenser housing, wherein said compact assembly comprises at least one antenna; and
communications electronics in electronic communication with said control system and adapted to receive signals including identification indicia from at least one remote communications unit using said at least one antenna.

25. The fuel dispenser of claim 24, wherein said fuel dispenser housing defines an aperture through which a connection is received from said compact assembly.

26. The fuel dispenser of claim 24, further comprising an antenna in said fuel dispenser housing, wherein said communications electronics are further adapted to receive signals including identification indicia from said at least one remote communications unit using said antenna in said fuel dispenser.

27. The fuel dispenser of claim 24, further comprising an antenna in said fuel dispenser housing, wherein said communications electronics are further adapted to receive signals including identification indicia from at least one remote communications unit that is different than said at least one communications unit using said antenna in said fuel dispenser.

28. The fuel dispenser of claim 26, wherein said at least one antenna of said compact assembly and said antenna in said fuel dispenser operate at different frequencies.

29. The fuel dispenser of claim 24, further comprising a tuning element in said fuel dispenser housing adapted to maintain the tuning of said at least one antenna of said compact assembly.

30. The fuel dispenser of claim 24, wherein said exterior surface is a bezel.

31. The fuel dispenser of claim 24, further comprising electronics adapted to operate at least one audio or visual element interposed in a layer of said compact assembly.

32. The fuel dispenser of claim 31, wherein said at least one audio or visual element is a plurality of light-emitting diodes.

33. The fuel dispenser of claim 31, wherein said at least one audio or visual element is an electrophoretic display.

34. The fuel dispenser of claim 24, wherein said communications electronics includes a matching network.

35. The fuel dispenser of claim 24, wherein said compact assembly includes at least one tuning element.

36. A method for attaching a compact assembly to a fuel dispenser, comprising:
providing a compact assembly having circuitry and a connector, wherein said compact assembly comprises at least one antenna;
affixing said compact assembly to an exterior surface of said fuel dispenser; and
connecting said circuitry of said compact assembly to circuitry in said fuel dispenser via said connector.

37. The method of claim 36, wherein said circuitry of said compact assembly comprises communications electronics.

38. The method of claim 36, wherein said circuitry of said fuel dispenser comprises communications electronics.

39. The method of claim 36, wherein said a second antenna is located within a fuel dispenser housing of said fuel dispenser.

40. The method of claim 36, wherein a tuning element is located within a fuel dispenser housing of said fuel dispenser.

41. The method of claim 36, wherein said compact assembly has a flange and an electronics housing having communications electronics mounted therein.

42. The method of claim 41, wherein said communications electronics comprises a matching network.

43. The method of claim 36, wherein said exterior surface is a bezel.
